(19) United States
(12) Patent Application Publication
(10) Pub. No.: US 2009/0221086 A1
(43) Pub. Date: Sep. 3, 2009

(54) Detection method using metallic nano pattern and the apparatus thereof

(76) Inventors: Dong Han Ha, Daejeon (KR); Yong Ju Yun, Chungchengnam-do (KR); Sanghun Kim, Kyungsanbuk-do (KR); Hyung Ju Park, Busan (KR); Wan Soo Yun, Daejeon (KR); Yong Jai Cho, Daejeon (KR)

Correspondence Address: CLARK & BRODY, 1090 VERMONT AVENUE, NW, SUITE 250, WASHINGTON, DC, 20005, US

(21) Appl. No.: 12/289,386

(22) Filed: Oct. 27, 2008

(30) Foreign Application Priority Data
Feb. 28, 2008 (KR) 10-2008-0018135

(51) Int. Cl. G01N 21/00

(52) U.S. Cl. 436/164

(57) ABSTRACT

The present invention relates to an apparatus and a method for detecting the presence of a particular organic, inorganic, metallic, natural or synthetic biomaterial and the concentration thereof. More particularly, the present invention relates to an apparatus and a method for detecting the identity, presence or absence, and concentration of a material to be detected, by which the metal ions of the detection solution are reduced to metals by a material to be detected and are deposited as metallic nanoparticles, resulting in the change of the shape, size or pattern of the metallic nanoparticles, and the change in light transmittance caused thereby is measured to detect the presence or absence of the material and the concentration thereof.

### CROSS-REFERENCE TO RELATED APPLICATION

This application claims priority under 35 U.S.C. §119 the benefit of Korean Patent Application No. 10-2008-0018135, filed Feb. 28, 2008, the entire contents of which are incorporated herein by reference.

### BACKGROUND

1. Technical Field

The present invention relates to an apparatus and a method for detecting the presence of a particular organic, inorganic, metallic, natural or synthetic biomaterial and the concentration thereof. More particularly, the present invention relates to an apparatus and a method using a detection substrate wherein metallic nanoparticles are formed to have a predetermined pattern on a transparent substrate and a detection solution containing metal ions, by which the metal ions of the detection solution are reduced to metals by a material to be detected and are deposited as metallic nanoparticles, resulting in the change of the shape, size or pattern of the metallic nanoparticles, and the change in light transmittance caused thereby is measured to detect the presence or absence of the material and the concentration thereof.

2. Description of the Related Art

With the development of nanoparticle fabrication techniques, techniques for detecting various biomaterials including pathogens, proteins, etc. and for treating diseases utilizing nanoparticles are being developed. The techniques for detecting the presence of a particular biomolecule or the concentration thereof by measuring the change of color of a nanoparticle solution which occurs when the nanoparticles are clustered or separated as they interact with the biomolecules, e.g., complementary bonding with DNA molecules or antigen-antibody reaction, are advantageous in that the biomolecule can be detected without the need of labeling with an isotope or fluorescein.

When precious metal nanoparticles such as gold (Au) or silver (Ag) are irradiated with white light, light of a particular wavelength region is absorbed by the nanoparticles, thereby leading to collective vibrations of electrons, or surface plasmons, and resulting in a characteristic color of the nanoparticle solution. The absorption wavelength region changes depending on the shape and size of the nanoparticles and the medium surrounding them. The detection technique utilizing the color change of the nanoparticle solution is based on this phenomenon.

Recently, Willner et al. of the Hebrew University of Jerusalem [Y. Xiao et al. Angew. Chem. Int. Ed. 43, 4519-4522 (2004); M. Zayats et al. Nano Lett. 5, 21-25 (2005)] have proposed a new molecule detection method of measuring the change of spectroscopic characteristics, i.e., the change of light absorption spectrum, accompanied by the change of Au nanoparticle size caused by the catalytic action of biomolecules such as glucose or NAD(P)H. This technique is based on the fact that, in the presence of a particular molecule, Au ions dissolved in the solution are reduced and deposited on the surface of Au nanoparticles, thereby increasing the size of the nanoparticles, and the increase of the nanoparticle (i.e., light absorption) at given temperature and reaction time is proportional to the concentration of the molecule in the solution. However, this technique measures the change of the size of the light absorption peak only, which changes irregularly in the order of several to a few dozens of nanometers at best.

Van Duyne et al. of Northwestern University [A. H. Haes et al. J. Am. Chem. Soc. 124, 10596-10604 (2002); A. H. Haes et al. Nano Lett. 4, 1029-1034 (2004)] have presented a molecular detection method utilizing the change of spectroscopic characteristics accompanied when probe molecules coated on regularly arranged Ag nanoparticles bind with target molecules. When the probe molecule binds with the target molecule, the refractive index of the medium surrounding each nanoparticle is changed, which, in turn, leads to the change of light absorption spectrum. The extent of the spectrum change is determined by the concentration of the target molecule. However, this method is restricted in that, when the probe molecule binds with the target molecule, only the position of the light absorption peak is changed by scores of nanometers and the size of the light absorption peak remains unchanged. That is, with the conventional molecular detection methods utilizing the optical characteristics of nanoparticles, the change of either the size or the position of light absorption peak is used as parameter for detecting the presence and the concentration of a particular molecule.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art. Therefore, an object of the present invention is to provide a detection method and a detection apparatus which provide improved sensitivity and reliability by utilizing the change of both the size and position of light absorption peak as detection parameters without using labeling material such an isotope or fluorescein, and are capable of detecting the presence or absence of a particular organic, inorganic, polymer, metallic, natural or synthetic biomaterial and the concentration thereof.

More particularly, the present invention provides a detection method and a detection apparatus which provide high sensitivity and reliability using a detection substrate wherein metallic nanoparticles are formed to have a predetermined pattern and on a transparent substrate and a detection solution containing metal ions, by which the initial position of light transmittance peak of the detection substrate is controllable from the UV to IR region.

The present invention is characterized by a method for detecting a material using a metallic nanopattern, comprising the steps of: a) contacting a detection solution containing metal ions with a detection substrate comprising a transparent substrate and metallic nanoparticles formed on the transparent substrate to have a predetermined pattern; b) adding a reaction solution containing a material to be detected which reduces the metal ions to the detection solution; and c) measuring light transmittance of the detection substrate separated from the mixture of the detection solution and the reaction solution.

The shape, size or pattern of the metallic nanoparticles is changed as the metal ions are reduced and deposited to metallic nanoparticles by the material to be detected of the reaction solution.

Preferably, a reference measurement step of measuring light transmittance of the detection substrate is included prior to the step a). Through the change of light transmittance before and after the reaction with the reaction solution, the presence or absence of the particular material can be detected, and the concentration of the material can be detected quantitatively based on the change of the light transmittance.

For the measurement of the light transmittance, light having a broadband wavelength in the region from IR to UV is irradiated to the detection substrate. The light transmittance is the transmittance of light having a broadband wavelength in the region from IR to UV. The wavelength region of the light transmittance measured in the reference measurement having a maximum or minimum light transmittance is controlled to the region from IR to UV by the pattern of the metallic nanoparticles.

Preferably, the metallic nanoparticles have a size from 10 nm to 1000 nm. The shape of the metallic nanoparticles is not particularly restricted.

The pattern of the metallic nanoparticles is composed of a motif having a polygonal lattice selected from a rectangle lattice, a square lattice, a hexagon lattice or an oblique lattice as unit cell, having one or more metallic nanoparticles at each apex of the polygon and at the center thereof. Preferably, each side of the polygon is from 100 nm to 5000 nm long.

Depending on the size of the metallic nanoparticles and the shape and size of the polygon, the wavelength region having the maximum or minimum light transmittance is controlled to the region from IR to UV.

Preferably, for the detection of very low concentrations, the motif is formed of from 1 to 6 metallic nanoparticles, and the spacing between the metallic nanoparticles forming the motif is from 0 nm to 200 nm.

Preferably, the identity and the concentration of the material to be detected are determined using a lookup table listing light transmittance of various materials, light transmittance at various concentrations, and various measurement conditions. Preferably, the identity of the material is the identity of an organic, polymer, inorganic, metallic, natural or synthetic biomaterial, the measurement condition has the volume of the detection solution, the concentration of metal ions in the detection solution, the particular metal ions in the detection solution, the volume of the reaction solution, reaction temperature, reaction time, the material comprising the substrate, the material comprising the metallic nanoparticles, information of the pattern, or a combination thereof as parameters, the light transmittance of various materials is the light transmittance of said materials measured at various wavelengths under various parameters of said measurement conditions, and the light transmittance at various concentrations is the light transmittance of a particular material measured at various concentrations, at various wavelengths under various parameters of said measurement conditions.

The reaction temperature means the temperature of the reaction solution and the temperature of the detection solution. Preferably, the temperature of the reaction solution and the temperature of the detection solution are the same temperature. The reaction time means the time from the addition of the reaction solution to the detection solution until the separation of the detection substrate from the detection solution (the detection solution to which the reaction solution has been added).

The metallic nanoparticles are nanoparticles of Au, Pt, Ag, Cu, Pb, Sn, Ni, Co, Zn, Mn, Al or Mg, preferably Au, Pt or Ag. The metal ions included in the detection solution are Au, Pt, Ag, Cu, Pb, Sn, Ni, Co, Zn, Mn, Al or Mg ions, preferably Au, Pt or Ag ions. For easier deposition on the surface of the metallic nanoparticles (lower energy barrier for heterogeneous nucleation), the metallic nanoparticles and the metal ions are preferably the same materials.

The present invention is also characterized by a kit for detecting a material comprising: a detection substrate comprising a transparent substrate and metallic nanoparticles formed on the transparent substrate to have a predetermined pattern; and a reaction solution containing metal ions.

The detection kit of the present invention is characterized in that, as the detection substrate is contacted with the detection solution and the reaction solution containing a material to be detected which reduces the metal ions to the detection solution, the shape, size or pattern of the metallic nanoparticles is changed as the metal ions are reduced and deposited to metallic nanoparticles by the material to be detected.

Preferably, the detection kit of the present invention further comprises: a light source which provides light in the region from IR to UV; and a light detector which measures intensity of light at various wavelengths, wherein the identity, the presence or absence, and the concentration of the material to be detected are detected by measuring the light transmittance of the detection substrate separated from the mixture of the detection solution and the reaction solution at various wavelengths.

The transparent substrate is a glass substrate, a quartz substrate, a sapphire substrate, a transparent conductive substrate, or a composite substrate thereof. The metallic nanoparticles are nanoparticles of Au, Pt, Ag, Cu, Pb, Sn, Ni, Co, Zn, Mn, Al or Mg, preferably Au, Pt or Ag. The metal ions included in the detection solution are Au, Pt, Ag, Cu, Pb, Sn, Ni, Co, Zn, Mn, Al or Mg ions, preferably Au, Pt or Ag ions.

Preferably, the metallic nanoparticles have a size from 10 nm to 1000 nm. The shape of the metallic nanoparticles is not particularly restricted.

The pattern of the metallic nanoparticles is composed of a motif having a polygonal lattice selected from a rectangle lattice, a square lattice, a hexagon lattice or an oblique lattice as unit cell, having one or more metallic nanoparticles at each apex of the polygon and at the center thereof. Preferably, each side of the polygon is from 100 nm to 5000 nm long.

Preferably, the motif is formed of from 1 to 6 metallic nanoparticles, and the spacing between the metallic nanoparticles forming the motif is from 0 nm to 200 nm.

It is characterized that the detection substrate is fabricated by a top-down process. In more detail, the detection substrate is prepared by a process comprising: coating a resist on the transparent substrate; carrying out light exposure and development using light or electron beam to form a predetermined pattern; depositing metals; and removing the resist.

The detection method according to the present invention enables a simple and quick detection of identity, presence or absence, and concentration of a material without labeling, and is applicable to any organic, inorganic or polymer biomaterial that reduces metal ions. Since the spectroscopic characteristics of the pattern (arrangement) of the metallic nanoparticles on the detection substrate are changed depending on the shape and size of the nanoparticles forming the pattern (arrangement) and on the distance between the nanoparticles, a trace amount of the material to be detected can be detected with high sensitivity. Further, by making the metallic nanoparticles formed on the detection substrate have a specific, not random, pattern, a detection result with reproducibility and reliability can be attained. And, because the change of light transmittance at various wavelengths following the reaction with the reaction solution can be measured accurately, the material to be detected can be detected with high accuracy.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates a process of preparing a detection substrate in accordance with the present invention;

FIG. 2 illustrates unit cells of a pattern (arrangement) of metallic nanoparticles formed on a detection substrate in accordance with the present invention;

FIG. 3 illustrates exemplary motifs positioned at each point of the polygons illustrated in FIG. 2;

FIG. 4 illustrates an exemplary motif [FIG. 3(3)] wherein the motif consists of squared unit cells, each apex of the square consisting of three metallic nanoparticles arranged in a regular triangle shape;

FIG. 5 illustrates a preferred flowchart for a method for detecting a material using a metallic nanopattern in accordance with the present invention;

FIG. 6 illustrates a block diagram of an exemplary apparatus for measuring light transmittance of the detection substrate in accordance with the present invention;

FIG. 7 is a scanning electron microscopic (SEM) image of an Au detection substrate in accordance with the present invention;

FIG. 8 is an optical microscopic image of an Au detection substrate in accordance with the present invention;

FIG. 9 shows SEM images of an Au detection substrate in accordance with the present invention at different reaction time, using the Au detection substrate, an Au detection solution (a solution containing Au ions), and aqueous NH₂OH solution as reaction solution;

FIG. 10 shows the measurement result of the change of light transmittance of the detection substrate of FIG. 9; and

FIG. 11 shows the change of position and size of light transmittance peak of the detection substrate.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations and shapes will be determined in part by the particular intended application and use environment.

### DETAILED DESCRIPTION OF THE INVENTION

Hereinafter, reference will now be made in detail to a detection method and a detection kit according to the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined in the appended claims.

Unless defined otherwise, the technical and scientific terms used in this description are meant to have the meanings commonly understood by those skilled in the art. In the description and appended drawings that follow, description of previously known functions and constructions which may unnecessarily obscure the subject matter of the present invention will be omitted.

The present invention is characterized by a method for detecting a material using a metallic nanopattern, comprising the steps of: a) contacting a detection solution containing metal ions with a detection substrate comprising a transparent substrate and metallic nanoparticles formed on the transparent substrate to have a predetermined pattern; b) adding a reaction solution containing a material to be detected which reduces the metal ions to the detection solution; and c) measuring light transmittance of the detection substrate separated from the reaction solution.

As the metal ions in the detection solution are reduced by the material to be detected and deposited as metallic nanoparticles, the shape, size or arrangement of the metallic nanoparticles is changed. The change of light transmittance caused by this change is measured to detect the identity, presence or absence, and concentration of the material to be detected.

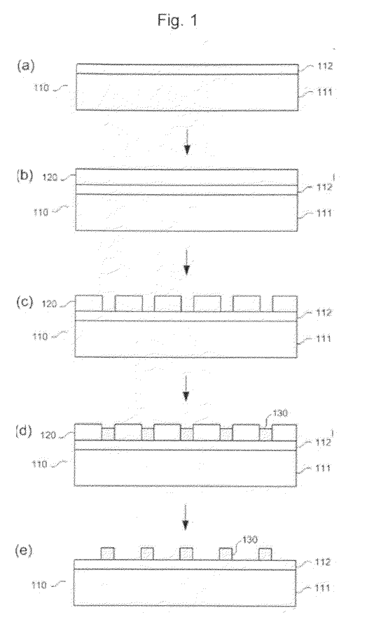

FIG. 1 illustrates a process of preparing a detection substrate in accordance with the present invention. As illustrated in FIG. 1, on a transparent substrate 110, which is a composite substrate comprising a glass substrate 111 and an ITO (indium tin oxide) film 112, an electron beam resist (PMMA) 120 is coated [FIG. 1(b)], and then, a process of light exposure and development is carried out to form a predetermined pattern using the electron beam resist [FIG. 1(c)]. Subsequently, Au, Pt, Ag, Cu, Pb, Sn, Ni, Co, Zn, Mn, Al or Mg metal is deposited to form metallic nanoparticles 130 on the transparent substrate 110, and the electron beam resist is removed by a lift-off process to prepare a detection substrate. Through this top-down process, the size, shape and arrangement of the metallic nanoparticles 130 can be controlled by controlling the size, shape, arrangement, etc. of the pores formed in the resist. Further, depending on the pore size and the metal deposition condition, the metallic nanoparticles 130 may be formed as single grains or polygrains.

In the example illustrated in FIG. 1, the nano-sized predetermined pattern is formed using electron beam and an electron beam resist. Alternatively, it may be formed using light and a photoresist, self-assembled polymer particle layers, nano imprinting, or the like. Also, although an example of preparing the composite substrate comprising the glass substrate 111 and the ITO film 112 as the transparent substrate 110 is illustrated in FIG. 1, any transparent material having good light transmittance and being chemically and physically stable may be used as the transparent substrate of the present invention.

Since the detection substrate according to the present invention is prepared by a top-down process, as illustrated in FIG. 1, rather than by a bottom-up process by which nanoparticles are formed irregularly, the size, arrangement, shape, etc. of the metallic nanoparticles formed on the transparent substrate can be controlled and metallic nanoparticles with specifically designed size and shape can be formed on the wanted positions on the transparent substrate with various arrangements, with small processing errors.

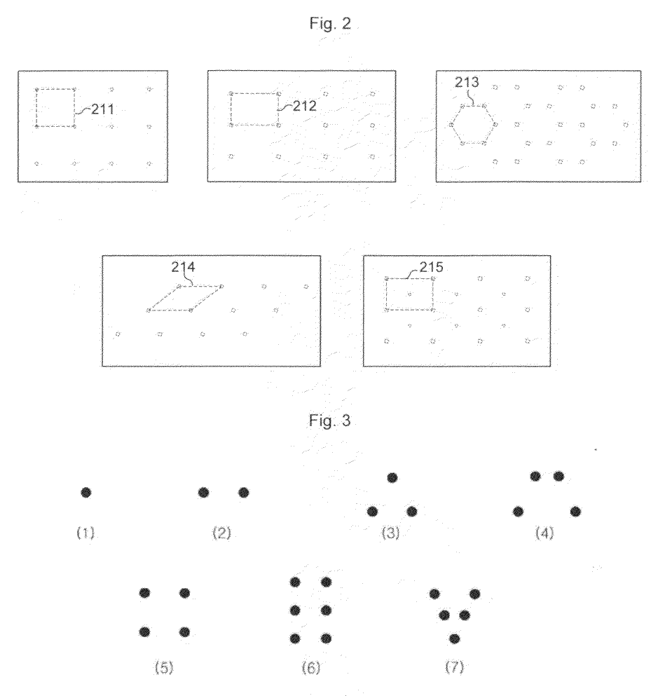

FIG. 2 illustrates unit cells of a pattern (arrangement) of metallic nanoparticles formed on a detection substrate in accordance with the present invention. As illustrated in FIG. 2, the metallic nanoparticles of the present invention have a square lattice 211, a rectangular lattice 212, a hexagonal lattice 213, an oblique lattice 214 or a centered rectangular lattice 215 as repeating unit cell.

In FIG. 2, the circle drawn with broken lines represents the apex of the repeating unit cell (211, 212, 213, 214 or 215 of FIG. 2) or the center thereof (215 of FIG. 2). A motif consisting of one or more metallic nanoparticles are positioned at each of the circle drawn with the broken lines to form an actual pattern (arrangement). The motif is actually positioned at each point (apex and center) of the polygons illustrated in FIG. 2, which are unit cells characterized by periodicity and two-dimensional space filling. The number of the metallic nanoparticles making up the motif is not restricted. In practice, the motif is made up of from 1 to 6 metallic nanoparticles.

FIG. 3 illustrates exemplary motifs positioned at each point of the polygons illustrated in FIG. 2. Most simply, a single metallic nanoparticle may be positioned at each point of the polygon [FIG. 3(1)]. Two linearly aligned metallic nanoparticles may form a motif [FIG. 3(2)], and three to six metallic nanoparticles may form a motif, as illustrated in FIG. 3(3) through FIG. 3(7). As illustrated in FIG. 3(4) and FIG. 3(5), even when the same number (4) of metallic nanoparticles forms a motif, they may have different shapes.

Further, although the metallic nanoparticles illustrated in FIG. 3 have a dot shape, they may be formed to have various shapes, including spherical, triangular, rectangular and elliptic shapes.

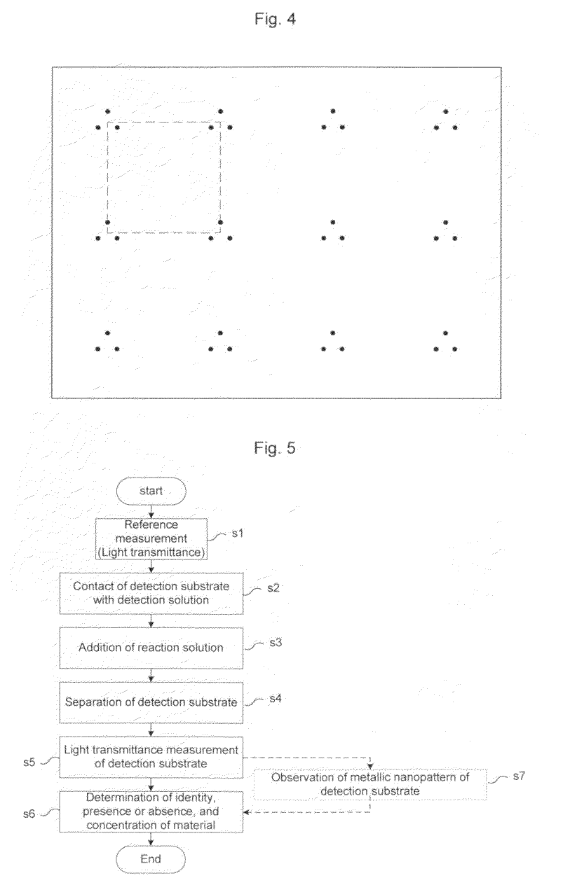

FIG. 4 illustrates an exemplary motif [FIG. 3(3)] wherein the motif consists of squared unit cells, each apex of the square consisting of three metallic nanoparticles arranged in a regular triangle shape.

As illustrated in FIG. 4, the metallic nanoparticles are arranged on the transparent substrate as a polygonal shape illustrated in FIG. 2 and as a motif illustrated in FIG. 3. Depending on the length of each side of the polygon and the arrangement shape and number of the metallic nanoparticles making up the motif, the peak position of the initial light transmittance is controlled and adjusted to be located in the wavelength region from IR to UV. Also, depending on the length of each side of the polygon and the arrangement shape and number of the metallic nanoparticles making up the motif, even a trace amount of the material to be detected can be detected, as the change of light transmittance of the material to be detected can be made very large.

For instance, let's suppose that the metallic nanoparticles are formed to have a pattern illustrated in FIG. 4. As the metal ions in the detection solution are reduced by the material to be detected and deposited, the shape of the motif which was originally a regular triangle may be changed to form a hollow ring. As a result, the light transmittance becomes totally different from the initial light transmittance, and consequently, the sensitivity and accuracy of detection are improved.

As described, in order to improve easiness of actual fabrication process and sensitivity, accuracy and reliability of detection, the metallic nanoparticles preferably have a size from 10 nm to 1000 nm. Also, preferably, each side of the polygon illustrated in FIG. 2 is from 100 nm to 5000 nm long. For the detection of very low concentrations, the motif is formed of from 1 to 6 metallic nanoparticles, and the spacing between the metallic nanoparticles forming the motif is from 0 nm to 200 nm. The interparticular spacing of 0 nm means that the metallic nanoparticles making up the motif are contacting with each other. In this case, the shape of the pattern is changed at the contact point of the metallic nanoparticles as the metal ions included in the detection solution are reduced and deposited.

Further, since the detection substrate is fabricated such that the metallic nanoparticles are arranged variously (polygonal shapes illustrated in FIG. 2 and motifs illustrated in FIG. 3) by a top-down process, as illustrated in FIG. 1, control and adjustment of peak position of initial light transmittance are easy, deviation from the intended design is small, and accurate patterning on wanted positions on the transparent substrate is possible. Further, it is advantageous that, as the initial light transmittance at various wavelengths can be controlled and adjusted, the change of light transmittance at various wavelengths can be measured accurately, and thus, the material to be detected can be detected with high accuracy.

FIG. 5 illustrates a preferred flowchart for a method for detecting a material using a metallic nanopattern in accordance with the present invention. The method for detecting a material using a metallic nanopattern in accordance with the present invention comprises the steps of: contacting a detection solution containing metal ions with a detection substrate comprising a transparent substrate and metallic nanoparticles formed on the transparent substrate to have a predetermined pattern (s2); adding a reaction solution containing a material to be detected which reduces the metal ions to the detection solution (s3); and measuring light transmittance of the detection substrate separated from the reaction solution (s4, s5).

In more detail, prior to contacting the detection substrate with the detection solution, light having a broadband wavelength in the region from IR to UV is irradiated vertically to the detection substrate to measure the initial light transmittance of the detection substrate as reference (s1). Then, the detection substrate is contacted with the detection solution (s2). The detection solution contains Au, Pt, Ag, Cu, Pb, Sn, Ni, Co, Zn, Mn, Al or Mg ions. Preferably, the metal ions are the ions of the metallic nanoparticles that constitute the detection substrate. The metal ions included in the detection solution may be in the form of either single atom metal ions or metal complexes. Preferably, the reference measurement is made as follows. First, light transmittance of a transparent substrate with no metallic nanoparticles formed thereon is measured. Then, light transmittance of the portion where the metallic nanopattern is formed is measured. Thus light transmittance purely by the metallic nanopattern calculated from the difference is used as reference.

In the state where the detection solution contacts the detection substrate, preferably in the state where the detection substrate is immersed in the detection solution, the reaction solution is added to the detection solution (s3). The reaction solution is a solution containing a material to be detected. The material to be detected that can be detected by the detection method according to the present invention may be any material capable of reducing the Au, Pt, Ag, Cu, Pb, Sn, Ni, Co, Zn, Mn, Al or Mg ions, preferably Au, Pt or Ag ions, included in the detection solution. Accordingly, the material to be detected may be a metallic, organic, inorganic, polymer, natural or synthetic biomaterial that can reduce the metal ions of the detection solution. The biomaterial includes a natural or synthetic biopolymer, cell, tissue, protein or a genetic material which easily loses electrons or has a functional group that easily loses electrons. The reaction solution includes a solution in which the material to be detected is simply dispersed, as well as one in which the material to be detected is dissolved.

When the reaction solution is added to the detection solution (s3), the metal ions of the detection solution are reduced to metals by the material to be detected included in the reaction solution and deposited as metallic nanoparticles. After a predetermined period of time, the detection substrate is separated from the detection solution and washed (s4). Then, light transmittance is measured again (s5) under the same condition as in the reference measurement (s1). The light transmittance measured at various wavelengths is compared with the reference so as to determine the identity, presence or absence, and concentration of the material to be detected (s6). At this time, the detection substrate may be observed supplementarily using an optical microscope, a scanning electron microscope (SEM), etc. (s7), in order to confirm the presence or absence of the material to be detected or qualitative characteristics based on the change of the size, shape and pattern of the metallic nanoparticles from the initial (ab initio) state.

The light transmittance measurement condition, the concentration of the metal ions in the detection solution, the volume and addition amount of the reaction solution, and the like should be controlled quantitatively because they are important factors that affect the detection result.

Preferably, in the step (s6), the identity and the concentration of the material to be detected is determined using a lookup table listing light transmittance of various materials, light transmittance at various concentrations, and various measurement conditions. The identity of the material is the identity of an organic, polymer, inorganic, metallic, natural or synthetic biomaterial. The measurement condition has the volume of the detection solution, the concentration of metal ions in the detection solution, the particular metal ions in the detection solution, the volume of the reaction solution, reaction temperature, reaction time, the material comprising the substrate, the material comprising the metallic nanoparticles, information of the pattern, the intensity of the irradiated light, the wavelength region of the irradiated light, information of the optical apparatus used to irradiate the light on the detection substrate, or a combination thereof as parameters. The light transmittance of various materials is the light transmittance of said materials measured at various wavelengths under various parameters of said measurement conditions, and the light transmittance at various concentrations is the light transmittance of a particular material measured at various concentrations, at various wavelengths under various parameters of said measurement conditions.

The reaction temperature means the temperature of the reaction solution and the temperature of the detection solution. Preferably, the temperature of the reaction solution and the temperature of the detection solution are the same temperature.

The reaction time means the time from the addition of the reaction solution to the detection solution until the separation of the detection substrate from the detection solution (the detection solution to which the reaction solution has been added). Preferably, the detection solution to which the reaction solution has been added is stirred adequately during the reaction time, so that a homogeneous solution status can be maintained.

The light transmittance means the light transmittance at various wavelengths, and the change of light transmittance means the change of wavelength having maximum or minimum light transmittance peak, change of the value of maximum or minimum light transmittance, appearance or disappearance of local light transmittance peak, and change of light transmittance at a given wavelength.

For the light transmittance measurement, light having a broadband wavelength in the region from IR to UV is irradiated vertically to the detection substrate and the intensity of the light passing through the detection substrate is measured at various wavelengths. The light transmittance measurement is made under a condition quantitatively controlled by the measurement condition. A filter, a polarizing filter, a mirror, a lens, etc. may be used to control the wavelength region of the irradiated light.

A kit for detecting a material using a metallic nanopattern to which the afore-described detection method of the present invention is applied comprises: a detection substrate comprising a transparent substrate and metallic nanoparticles formed on the transparent substrate to have a predetermined pattern; and a reaction solution containing metal ions.

The detection kit of the present invention is characterized in that, as the detection substrate is contacted with the detection solution and the reaction solution containing a material to be detected which reduces the metal ions to the detection solution, the shape, size or pattern of the metallic nanoparticles is changed as the metal ions are reduced and deposited as metallic nanoparticles by the material to be detected.

In the detection kit, the detection substrate, the detection solution and the material to be detected are similar to those described above with respect to the detection method of the present invention.

Preferably, the detection kit of the present invention further comprises: a light source which provides light in the region from IR to UV; and a light detector which measures intensity of light at various wavelengths, wherein the identity, the presence or absence, and the concentration of the material to be detected are detected by measuring the light transmittance of the detection substrate separated from the mixture of the detection solution and the reaction solution at various wavelengths.

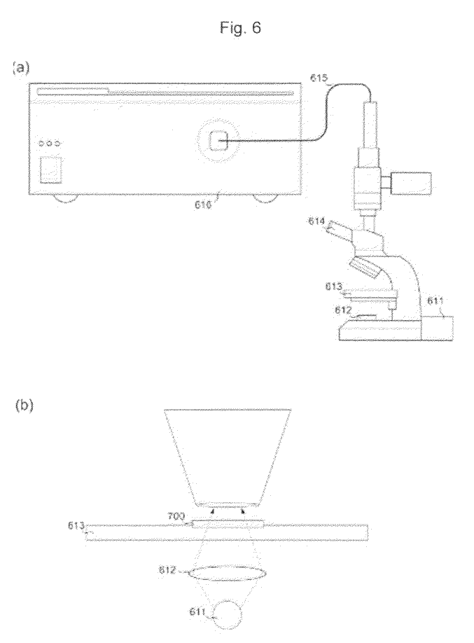

In more detail, as illustrated in FIG. 6, a lens 612 is provided to effectively irradiated light from a white light source 611. Position control stages 613, 614 enable the confirmation and adjustment of the location of the detection substrate 700 in real time. The light passing through the detection substrate 700 is transmitted to a light detector 616 by way of an optical fiber 615. The intensity of the light transmitted via the optical fiber 615 at various wavelengths is determined by the light detector 616.

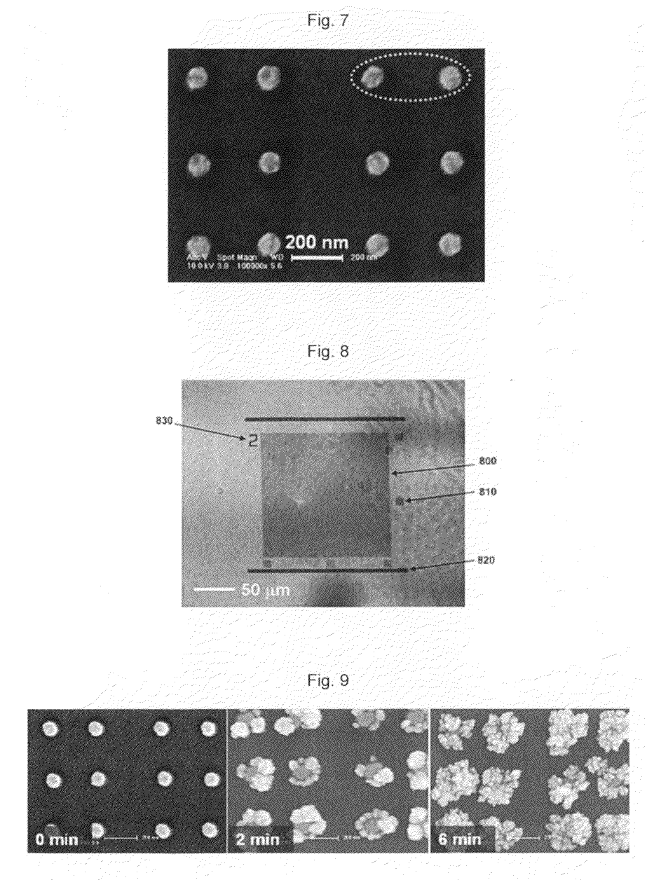

FIG. 7 is an SEM image of an Au detection substrate prepared in accordance with the process illustrated in FIG. 1. The detection substrate of FIG. 7 was prepared by coating a composite substrate comprising a glass substrate and an ITO film with a 150 nm thick electron beam resist, carrying out light exposure and development using electron beam such that pores with a pattern as shown in FIG. 7 were formed, depositing Au in the pores, and removing the electron beam resist.

On the detection substrate shown in FIG. 7, about 90 nm sized, circular disc-shaped nanoparticles formed a predetermined pattern. As can be seen from the SEM image, a motif having a rectangle lattice with a size of 350 nm×700 nm as unit cell was obtained, with the spacing between two Au nanoparticles approximately 200 nm (broken line in FIG. 7).

FIG. 8 is an optical microscopic image of the detection substrate of FIG. 7. The large rectangle 800 having an area of 160 160 μm² at the center is a region for measuring light transmittance of the transparent substrate on which Au nanoparticles are arranged to have a predetermined pattern. The five smaller dark squares 810 having an area of 10 10 μm² are the Au nanoparticle patterns (arrangement) to be observed by SEM. The black lines 820 above and below the region 800 wherein the Au nanoparticles are arranged are guide lines to help find the region wherein the Au nanoparticles are arranged easily. The number 830 on the left upper side is an identification number which informs the particular shape of the metallic nanopatterns when different patterns (arrangements) are formed on a single substrate.

FIG. 9 shows SEM images of the Au detection substrate at different reaction time, using the Au detection substrate, an Au detection solution (a solution containing Au ions), and aqueous NH₂OH solution as reaction solution;

The Au detection substrate of FIG. 7 and FIG. 8 was used, and a detection solution containing Au ions was prepared by adding 1 mL of 400 μM aqueous HAuCl₄ solution to 10 mL of distilled water. The Au detection substrate (a glass/ITO composite substrate on which Au nanoparticles was formed to have the pattern of FIG. 7) was immersed in a detection solution maintained at 28° C. Then, after adding 1 mL of 210 μM aqueous NH₂OH solution as reaction solution, followed by stirring for 2 minutes and 6 minutes respectively, the detection substrate was separated from the solution and dried after washing with distilled water. All the above procedures were carried out at 28° C.

As seen from FIG. 9, as the Au ions included in the detection solution were reduced and deposited on the surface of the Au nanoparticles by the material to be detected NH₂OH in the reaction solution, the size and shape of the Au nanoparticles and the distance between the two Au nanoparticles of the motif changed gradually. After 6 minutes of reaction time, the two Au nanoparticles were nearly contacting each other. As a result, it was confirmed that the motif itself can be changed by increasing the reaction time.

For the measurement of change of light transmittance of the detection substrate before and after reaction with the reaction solution, the light passing through the sample placed on the stage of a microscope (Olympus, BX51W1) as illustrated in FIG. 6 was focused using an objective lens, and its spectroscopic characteristics was analyzed using a multi-channel spectrometer (Hamamatsu, PMA-11). By comparing the light transmittance of a substrate between the portion where the nanopattern was formed and the portion where the nanopattern was not formed, the light transmittance purely by the nanopattern was measured. Light emitted from a 100 W halogen lamp was focused with a lens and irradiated vertically on the sample. A polarizer was placed between the halogen lamp and the detection substrate such that the light polarized horizontally with reference to the pattern of FIG. 9, e.g., along the direction connecting the two Au nanoparticles of the motif, was incident.

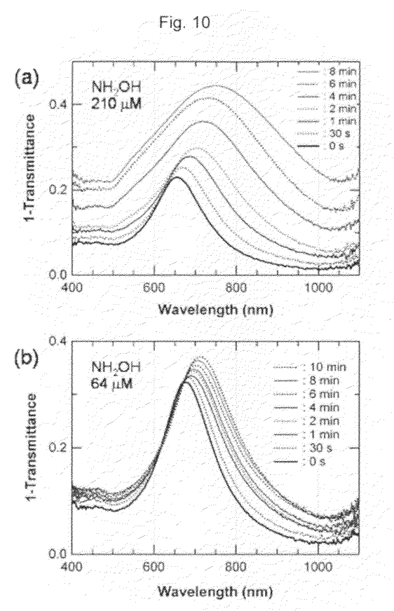

FIG. 10 shows the measurement result of the change of light transmittance of the detection substrate of FIG. 9. The same reaction solution was used in FIG. 10(a) and FIG. 10(b), but the concentration of the material to be detected NH₂OH was different at 210 μM and 64 μM respectively.

When the NH₂OH concentration was 210 μM, the position of light transmittance peak was initially at 655 nm [0 s in FIG. 10(a)]. However, as the size, shape and arrangement of the Au nanoparticles were changed, the peak was shifted remarkably to near 750 nm after 8 minutes of reaction [8 min in FIG. 10(a)]. Further, the intensity of the light transmittance peak, which was initially 0.239, increased continuously with the reaction time and reached 0.445 after 8 minutes of reaction. That is, as the change of the nanopattern proceeded, the change of the position and the size of light transmittance peak became larger.

When the concentration of the material to be detected NH₂OH was 64 μM, the position and the size of light transmittance peak also changed continuously with the reaction time, as seen in FIG. 10(b). However, the degree of change was significantly smaller as compared when the NH₂OH concentration was 210 μM. That is, the change of the position and the size of light transmittance peak are very sensitive to the concentration of the material to be detected.

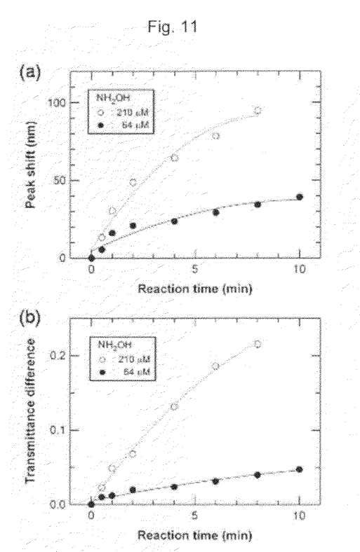

FIG. 11 shows the change of position and size of light transmittance peak of the detection substrate depending on the reaction time and the concentration of the material to be detected NH₂OH. For the same reaction time, the change of position and size of light transmittance peak was proportional to the concentration of the material to be detected. At the same concentration of the material to be detected, the change of position and size of light transmittance peak increased with the reaction time. Therefore, as seen in FIG. 11, both the change of position and size of light transmittance peak can be utilized as detection parameter for detecting the presence or absence and the concentration of the material to be detected.

As apparent from the above description, in accordance with the present invention, presence or absence and concentration of a particular material can be detected using a predetermined pattern of metallic nanoparticles, without the need of labeling using an isotope or fluorescein. Further, even a trace amount of a particular molecule can be detected with high resolution and reliability, as the change of position and size of light transmittance peak accompanied by the change of the nanopattern is measured at the same time, differently from the previous methods in which the change of either position or size of light absorption peak is used as detection parameter.

Also, as the change of light transmittance of the nanopattern with predetermined size, shape and periodicity is measured, differently from the methods using irregularly distributed nanoparticles formed by a bottom-up process, the initial position of light transmittance peak can be adjusted as wanted in the wavelength region from IR to UV. Since the position of light transmittance peak is sensitive not only to the size of nanoparticles but also to the distance between the nanoparticles, the position of the light transmittance peak changes greatly. Further, as the size of the peak also changes simultaneously, the identity and the concentration of even a trace amount of a particular molecule can be detected accurately. In addition, the small size of the detection unit enables the detection apparatus to be manufactured as a microdevice. Also, as can be seen from FIG. 10 and FIG. 11, by adopting a bottom-up chemical reaction process rather than a top-down process, it is possible to minutely adjust the position of light transmittance peak within the range of several hundred nanometers.

The invention has been described in detail with reference to preferred embodiments thereof. However, it will be appreciated by those skilled in the art that changes may be made in these embodiments without departing from the principles and spirit of the invention, the scope of which is defined in the accompanying claims and their equivalents.

1. A method for detecting a material using a metallic nanopattern, comprising the steps of:
a) contacting a detection solution containing metal ions with a detection substrate comprising a transparent substrate and metallic nanoparticles formed on the transparent substrate to have a predetermined pattern;
b) adding a reaction solution containing a material to be detected which reduces the metal ions to the detection solution; and
c) measuring light transmittance of the detection substrate separated from the mixture of the detection solution and the reaction solution.

2. The method for detecting a material using a metallic nanopattern as set forth in claim 1, wherein the shape, size or pattern of the metallic nanoparticles is changed as the metal ions are reduced and deposited to metallic nanoparticles by the material to be detected of the reaction solution.

3. The method for detecting a material using a metallic nanopattern as set forth in claim 1, further comprising a reference measurement step of measuring light transmittance of the detection substrate prior to the step a).

4. The method for detecting a material using a metallic nanopattern as set forth in claim 3, wherein the identity and the concentration of the material to be detected are detected based on the light transmittance measured in the reference measurement and the light transmittance measured in the step c).

5. The method for detecting a material using a metallic nanopattern as set forth in claim 1, wherein the light transmittance is the transmittance of light having a broadband wavelength in the region from IR to UV.

6. The method for detecting a material using a metallic nanopattern as set forth in claim 3, wherein the wavelength region of the light transmittance measured in the reference measurement having a maximum or minimum light transmittance is controlled to the region from IR to UV by the pattern of the metallic nanoparticles.

7. The method for detecting a material using a metallic nanopattern as set forth in claim 1, wherein the pattern is composed of a motif having a polygonal lattice selected from a rectangle lattice, a square lattice, a hexagon lattice or an oblique lattice as unit cell, having one or more metallic nanoparticles at each apex of the polygon and at the center thereof.

8. The method for detecting a material using a metallic nanopattern as set forth in claim 1, wherein the metallic nanoparticles have a size from 10 nm to 1000 nm.

9. The method for detecting a material using a metallic nanopattern as set forth in claim 7, wherein each side of the polygon is from 100 nm to 5000 nm long.

10. The method for detecting a material using a metallic nanopattern as set forth in claim 7, wherein the motif is formed of from 1 to 6 metallic nanoparticles.

11. The method for detecting a material using a metallic nanopattern as set forth in claim 7, wherein the spacing between the metallic nanoparticles forming the motif is from 0 nm to 200 nm.

12. The method for detecting a material using a metallic nanopattern as set forth in claim 4, wherein the identity and the concentration of the material to be detected are determined using a lookup table listing light transmittance of various materials, light transmittance at various concentrations, and various measurement conditions.

13. The method for detecting a material using a metallic nanopattern as set forth in claim 12, wherein the identity of the material is the identity of an organic, polymer, inorganic, metallic, natural or synthetic biomaterial,
the measurement condition has the volume of the detection solution, the concentration of metal ions in the detection solution, the particular metal ions in the detection solution, the volume of the reaction solution, reaction temperature, reaction time, the material comprising the substrate, the material comprising the metallic nanoparticles, information of the pattern, or a combination thereof as parameters,
the light transmittance of various materials is the light transmittance of said materials measured at various wavelengths under various parameters of said measurement conditions, and
the light transmittance at various concentrations is the light transmittance of a particular material measured at various concentrations, at various wavelengths under various parameters of said measurement conditions.

14. The method for detecting a material using a metallic nanopattern as set forth in claim 1, wherein the light irradiated to measure the light transmittance is light in the region from IR to UV.

15. The method for detecting a material using a metallic nanopattern as set forth in claim 1, wherein the metallic nanoparticles are nanoparticles of Au, Pt, Ag, Cu, Pb, Sn, Ni, Co, Zn, Mn, Al or Mg, and the metal ions are Au, Pt, Ag, Cu, Pb, Sn, Ni, Co, Zn, Mn, Al or Mg ions.

16. A kit for detecting a material using a metallic nanopattern comprising:
a detection substrate comprising a transparent substrate and metallic nanoparticles formed on the transparent substrate to have a predetermined pattern; and
a reaction solution containing metal ions.

17. The kit for detecting a material using a metallic nanopattern as set forth in claim 16, wherein, as the detection substrate is contacted with the detection solution and the reaction solution containing a material to be detected which reduces the metal ions to the detection solution, the shape, size or pattern of the metallic nanoparticles is changed as the metal ions are reduced and deposited to metallic nanoparticles by the material to be detected.

18. The kit for detecting a material using a metallic nanopattern as set forth in claim 16, further comprising:
a light source which provides light in the region from IR to UV; and
a light detector which measures intensity of light at various wavelengths, wherein
the identity, the presence or absence, and the concentration of the material to be detected are detected by measuring the light transmittance of the detection substrate separated from the mixture of the detection solution and the reaction solution at various wavelengths.

19. The kit for detecting a material using a metallic nanopattern as set forth in claim 16, wherein the transparent substrate is a glass substrate, a quartz substrate, a sapphire substrate, a transparent conductive substrate, or a composite substrate thereof.

20. The kit for detecting a material using a metallic nanopattern as set forth in claim 16, wherein the detection substrate is prepared by a process comprising:
coating a resist on the transparent substrate;
carrying out light exposure and development using light or electron beam to form a predetermined pattern;
depositing metals; and
removing the resist.

21. The kit for detecting a material using a metallic nanopattern as set forth in claim 16, wherein the metallic nanoparticles are nanoparticles of Au, Pt, Ag, Cu, Pb, Sn, Ni, Co, Zn, Mn, Al or Mg, and the metal ions are Au, Pt, Ag, Cu, Pb, Sn, Ni, Co, Zn, Mn, Al or Mg ions.

22. The kit for detecting a material using a metallic nanopattern as set forth in claim 16, wherein the metallic nanoparticles have a size from 10 nm to 1000 nm.
